(19) United States
(12) Patent Application Publication
(10) Pub. No.: US 2005/0260409 A1
(43) Pub. Date: Nov. 24, 2005

(54) Mechanically and thermally responsive polymer yarn for industrial fabric application and industrial fabric

(75) Inventors: Dwight Payne, St. Simons Island, GA (US); Gilbert Ross, Waycross, GA (US); Heping Zhang, Summerville, SC (US); Antony Morton, Ben Rhydding (GB); Craig Valentine, Summerville, SC (US)

Correspondence Address: GREENBLUM & BERNSTEIN, P.L.C., 1950 ROLAND CLARKE PLACE, RESTON, VA, 20191, US

(73) Assignee: VOITH FABRICS PATENT GMBH, Heidenheim (DE)

(21) Appl. No.: 10/986,167

(22) Filed: Nov. 12, 2004

Related U.S. Application Data
(63) Continuation-in-part of application No. 10/850,684, filed on May 21, 2004.

(51) Int. Cl. H01F 1/04

(52) U.S. Cl. 428/364

(57) ABSTRACT

Yarn for an industrial fabric which will be subjected to a heat set temperature during production. The yarn is made from polymeric material, the polymeric material includes a first phase and a second phase, wherein the melting temperature of the second phase is equal or less than the heat set temperature and wherein the melting temperature of the first phase is higher than the heat set temperature. Also provided are industrial fabrics with enhanced smoothness.

### FIELD OF INVENTION

The present invention relates to yarns made of polymeric material for use in industrial fabrics.

### DESCRIPTION OF PRIOR ART

Industrial fabrics, especially papermaking fabrics, are typically but not exclusively made of a woven structure using polymer yarns in the weft and warp direction. To improve the smoothness and the printability of a paper sheet produced on a papermaking fabric it is desirable to increase the smoothness and the contact area of the paper contacting surface of the papermaking fabric. Especially for high speed applications it is further desirable to increase the smoothness of the wear side of the papermaking fabric in order to improve the aerodynamic performance of the fabric.

The smoothness of the paper contacting surface can be improved by increasing the yarn density resulting in increased manufacturing costs and reduced permeability of the fabric.

Further the smoothness can be improved by using profiled monofilament yarns having flat surface. When using the flat shaped yarns, e.g. as warp yarns in float weave designs, the flat warp yarns provide greater surface contact area. It has been found that for many applications the gain in contact area by using such flat yarns is not sufficient. Especially for graphic and fine paper grades it would be desirable to bring the weft yarns as well as the warp yarns into the paper contacting surface of the papermaking fabric to increase the contact area and the smoothness of the fabric to a sufficient level.

### SUMMARY OF THE INVENTION

It is the object of the present invention to provide polymer yarns suitable for the use in industrial fabrics with which it is possible to overcome the disadvantages described above.

It is another object of the invention to provide industrial fabrics overcoming above described disadvantages.

According to a first aspect of the invention there is provided a yarn for an industrial fabric. Such an industrial fabric will be subjected to a maximum heat set temperature during production. The yarn according to the invention is made from polymeric material. The polymeric material includes a first phase having a melting temperature and a second phase having a melting temperature. According to the invention the melting temperature of the second phase is equal to or less than the maximum heat set temperature and the melting temperature of the first phase is higher than the maximum heat set temperature.

The idea of the invention is to provide a yarn having the ability for controllable deformation when subjected to mechanical tension and thermal heat, as is the case during heat set treatment for industrial fabrics. The yarn according to the invention is therefore made from a polymeric material including two different phases which have two different melting points wherein the melting temperature of the second phase is equal to or less than the maximum heat set temperature and wherein the melting temperature of the first phase is higher than the maximum heat set temperature.

The second phase takes over the part that the yarn softens during heat set treatment and the first phase take over the part that the yarn does not melt. Therefore by combining a first and second polymeric phase according to the invention a yarn is provided which softens during the heat set treatment and becomes very deformable without melting.

If the yarns according to the invention are, e.g., weft yarns of a woven industrial fabric and if the warp yarns of the fabric are made from standard yarn material, during heat set treatment the harder warp yarns can compress the softer and deformable weft yarns resulting in a crimp interchange between the warps and the wefts leading to a reduction of the warp knuckles giving a fabric with enhanced surface smoothness.

Typical maximum heat set temperatures are in the range of 90° C. to 260° C.

Further the industrial fabric will be operated on, e.g., a papermaking machine at a maximum operation temperature. Therefore, according to a preferred embodiment of the invention the melting temperature of the second phase is higher than the maximum operating temperature.

According to a preferred embodiment of the invention the polymeric material is a polymer blend wherein the first phase includes a first polymer component and wherein the second phase includes a second polymer component and wherein the first and the second polymer component are at least substantially immiscible. By blending immiscible polymer compounds most of the properties, e.g., the melting temperature of each polymer compound, will be maintained substantially.

It is further possible that the first and the second phase are of the same material and differ in their state of aggregation.

Depending on the application the maximum operation temperature for an industrial fabric is less than 90° C. or less 120° C. For papermaking fabrics maximum heat set temperatures are in the ranges as follows:

Forming fabrics: 170° C. to 190° C., typically 180° C. to 185° C.

Press fabrics: 160° C. to 185° C., typically 160° C. to 165° C.

Dryer fabrics: 180° C. to 220° C., typically 190° C.

Therefore the melting temperature of the second phase/second polymer component is in the range of 120° C. to 220° C., preferably in the range of 160° C. to 220° C.

By way of example:

A fabric will be subjected to a heat set treatment with a maximum temperature of 190° C. and will be operated at a maximum operation temperature of 120° C. Therefore the melting temperature of the second phase of a yarn according to the invention must be lower than 190° C. and higher than 120° C. The melting temperature of the first phase of this yarn is more than 190° C.

According to a further preferred embodiment of the invention the melting temperature of the second phase/second polymer component is at least 30° C. lower than the melting temperature of the first phase/first polymer component.

According to a further preferred embodiment of the invention the melting temperature of the second phase/second polymer component is at least 80° C. lower than the melting temperature of the first phase/first polymer component.

According to another preferred embodiment of the invention the melting temperature of the second phase/second polymer component is typically between 100° C. and 110° C. lower than the melting temperature of the first phase/first polymer component.

Further the first component includes any of the following either alone or blended: homopolymers and copolymers of the polyesters, homopolymers and copolymers of polyamides, polyphenylene sulphide (PPS).

Most preferably the first component includes polyethylene terephthalate (PET).

In addition the second component includes any of the following either alone or blended: polyolefins, polyamides, fluoropolymers.

Most preferably the second component includes Polyolefins.

It has been found by the applicant that yarns according to the invention showing the best deformability at the heat set temperature for which they are designed is a blend including between 51% and 99% by weight, preferably between 60% and 95% by weight, of the first component and between 49% and 1% by weight, preferably between 5% and 40% by weight, of the second component.

To allow the polymer blend to be processed it may be necessary to incorporate at least one suitable compatibilizer. Without a suitable compatibilizer, e.g., mechanical properties, e.g. toughness of the yarn produced can be reduced. Further for immiscible polymer blends the so called “die swell” during extrusion can increase which effects the controllability of the extruded yarn diameter. Therefore according to a further preferred embodiment the polymer blend includes at least one suitable compatibilizer.

It has been found by the applicant the best results in regard to processability can be achieved if the at least one compatibilizer is included in an amount of 0.01% to 10% by weight, preferably in an amount of 0.1 to 5% by weight.

There are different types of compatibilizer suitable for the polymer blend according to the invention. According to a preferred embodiment of the invention at least one compatibilizer is a physical compatibilizer. A physical compatibilizer is based on the principle that components of the compatibilizer are miscible which each component/phase of the blend. Thus the compatibilizer is acting as a polymeric surfactant.

According to a further preferred embodiment of the invention the physical compatibilizer is any of the following: Ethylene Methyl Acrylate Copolymer (EMA), Ethylene. Butyl Acrylate Copolymer (EBA). By way of example the blend includes the polymer components polyethylene (PE) and PET and the compatibilizer EMA. In this case the ethylene component of the compatibilizer is miscible with PE and the methacrylate component of the compatibilizer is miscible with PET.

A suitable compatibilizer also can be a reactive compatibilizer. This method of compatibilization relies e.g. on the chemical reaction between the functional group that is grafted onto the PE and the end groups of the PET. This results in the in-situ formation of a PET/PE copolymer which then acts as a physical compatibilizer for the blend.

The suitable reactive compatibilizer can be any of the following: Ethylene-g- Maleic Anhydride Copolymers, Ethylene-g- Glycidal Methacrylate.

Further the polymer blend can include at least one suitable stabilizer. A stabilizer for example is added to design yarns with the ability to withstand severe conditions as high temperature and/or high humidity. According to one preferred embodiment of the present invention the at least one stabilizer is a hydrolysis stabilizer. Hydrolysis stabilizers are added to the blend to generate yarns for the use under high humidity conditions.

The hydrolysis stabilizer can be a carbodiimide compound either monomeric, polymeric or a combination.

According to a further preferred embodiment of the invention the at least one stabilizer can be an anti-oxidation stabilizer. Anti-oxidation stabilizers are added to the blend to generate yarns for the use under high temperature conditions.

It has been found by the applicant that the best results in retaining the properties of the blend can be achieved if the at least one stabilizer is included in an amount of 0.1% to 10% by weight, preferably in an amount of 0.5 to 5% by weight.

According to a second aspect of the present invention there is provided a yarn for use in an industrial fabric, preferably a woven fabric, which has a tensile elongation of at least 10% at 1.75 grams per denier (gpd). Surprisingly applicant found out that especially a woven fabric at least in part comprising yarns having a tensile elongation of at least 10% at 1.75 grams per denier has improved properties in regard to surface smoothness and wear resistance.

Preferably, the tensile elongation at 1.75 grams per denier is between 15% and 30%.

According to a preferred embodiment of the present invention the yarn has a elongation at yield point 1 which is greater than 5% and/or an elongation at yield point 2 which is greater than 20%.

Further the yarn according to the invention preferably is a monofilament yarn but also can be a multifilament yarn.

The yarn according to the invention has a diameter in the range of 0.20 mm to 2.0 mm, preferable in the range of 0.4 mm to 1.0 mm. These diameters are suitable for most of the different types of papermakers' fabrics.

According to a further embodiment of the invention the shape of the yarn is round or profiled, e.g., with chamfered edges.

It has been found by the applicant that an industrial fabric comprising a set of weft yarns and a set of warp yarns, wherein the warp yarns and the weft yarns are interwoven to form a specific weave design, and wherein tension has been applied to the weft yarns or the warp yarns during a heat set treatment, has improved surface smoothness and wear resistance if at least one of the yarns of the fabric have not been tensioned during heat set treatment has an enhanced crimp level of at least 0.5% compared to the corresponding yarn of a reference fabric, wherein the reference fabric has the same weave design as the fabric, wherein all weft and warp yarns of the reference fabric have the same diameter as the weft and warp yarns of the fabric, wherein the reference fabric has been manufactured under the same conditions as the fabric, and wherein the corresponding not tensioned yarn of the reference fabric is made from PET based polymeric material.

By providing a fabric comprising yarns which have not been tensioned during heat set treatment and which have after heat set treatment an enhanced crimp level of at least 0.5% compared to yarns made from PET having the same position in a reference fabric as the yarns in the fabric, wherein the reference fabric being identical in all features and in manufacturing as the fabric according to the invention except that the similar/corresponding yarns are made from PET, the non tensioned yarns and the tensioned yarns of the fabric lie more together in one common plane of the fabric compared to the yarns in the reference fabric. This leads to a fabric according to the invention having enhanced smoothness, less tendency of wire marking and improved wear resistance.

The crimp level is calculated with the following formula:
(length along the crimped line of the yarn−length along the straight line of the yarn)/length along the straight line of the yarn*100=crimp level in %

By way of example for a given yarn the length along the crimped line of the yarn is 12 cm and the length along the straight line is 10 cm the crimp level is (12 cm-10 cm)/10 cm*100=20%.

According to a preferred embodiment of this aspect of the invention at least some of the yarns not being tensioned during heat set treatment have the enhanced crimp level compared to the corresponding yarns in the reference fabric.

According to most preferred embodiment of this aspect of the invention all of the yarns to which no tension has been applied to during heat set treatment have the enhanced crimp level.

Preferably the non-tensioned yarns are weft yarns.

According to a further preferred embodiment of the invention the enhanced level of crimp is at least 1.0%, preferably at least 1.5%, most preferably in the range of 1.5% to 2.5%. It has been found that with increasing crimp level the smoothness of the fabric increases. Further it has been found that an optimum in smoothness is achieved if the crimp level of the non-tensioned yarns during heat set treatment is in the range of 1.5% and 2.5%.

Typical heat set conditions are:
tension selected from the range of 1 kN/m to 6 kN/m,
temperature with a maximum temperature selected from the range of 90° C. to 260° C.

Further it has been found by the applicant that the paper contacting surface has an enhanced smoothness over the paper contacting surfaces of prior art papermaking fabrics leading to less sheet marking if the ratio of crimp level of the warp yarns to the crimp level of the weft yarns is as low as possible.

Therefore, according to another aspect of the invention there is provided an industrial fabric having a set of weft yarns and a set of warp yarns. The warp yarns and the weft yarns are interwoven with each other and have a crimp level after heat set treatment. During heat set treatment a tension in the range of 1 kN/m to 6 kN/m, preferably 1.5 kN/m to 5 kN/m and a temperature in the range of 90° C. to 260° C., preferably 160° C. to 220° C. has been applied to the warp yarns. According to the invention at least one warp yarn and at least one weft yarn have a crimp level ratio which is less than 4, wherein the crimp level for each yarn is the difference of the length along the crimped line of the yarn and the length along the straight line of the yarn divided through the length along the straight line of the yarn.

The second aspect of the invention will be explained by way of example as follows:

During heat set treatment, tension and temperature are applied to the warp yarns. At least some of the weft yarns are made from a material which softens at the maximum heat set temperature and therefore is very deformable at the maximum heat set temperature. Further the warp yarns are made from a material which softens less than the weft yarns at the maximum heat set temperature. The fact that the weft yarns are made from the material which softens more during heat set treatment than the warp yarns allows the harder warp yarns to compress the softer weft yarns reducing the warp knuckles leading to a smoother fabric.

Based on the discussion set forth below it is therefore desirable if the ratio of the crimp level of at least one warp yarn to the crimp level of at least one weft yarn is less than 3.5, preferably less than 3.0, most preferably less than 2.

According to a third aspect of the invention there is provided an industrial fabric including at least in part yarns made from a polymeric material, wherein the industrial fabric has been subjected to a heat set temperature during production, wherein the polymeric material includes a first phase and a second phase, and wherein the melting temperature of the second phase is equal or less than the heat set temperature and wherein the melting temperature of the first phase is higher than the heat set temperature.

According to a further preferred embodiment of the invention the yarns made of polymeric material having two phases are weft and/or warp yarns.

Further, it is desirable if the industrial fabric is a papermaking fabric, preferably a forming or a dryer fabric.

In the case of a dryer fabric the dryer fabric has an air permeability in the range from 50 to 200 cfm, preferably in the range from 75 to 150 cfm.

According to a preferred embodiment in regard to a specific weave design of the industrial fabric the set of weft yarns comprises first and second weft yarns, wherein the first weft yarns are disposed over the second weft yarns and wherein the warp yarns weave over two consecutive first weft yarns before weaving under one second weft yarn. It has been found by the applicant that a weave design according to this embodiment has improved surface smoothness.

According to an embodiment of the above mentioned weave design the first weft yarns are in offset position relative to the second weft yarns.

According to another embodiment of the weave design it is foreseen that adjacent warp yarns weave in offset position relative to each other over the two consecutive first weft yarns, wherein the offset position of the adjacent warp yarns preferably is at least one first weft yarn.

Preferably, the weave design comprise per weave repeat four warp yarns and four first and four second weft yarns.

The following examples are intended to illustrate the invention, not to limit it.

TABLE 1

| Composition | Reference | Sample 1 | Sample 2 | Sample 3 | Sample 4 |
|---|---|---|---|---|---|
| Component 1 | 100% | 98% | 95% | 91% | 87.3% |
| | PET | PET | PET | PET | PET |
| Component 2 | — | 2% PE | 5% PE | 5% PE | 5% PE |
| Additive 1 | — | — | — | 1% Anti- | 0.5% Anti-Oxidant |
| | | | | Oxidant | |
| Additive 2 | — | — | — | 3% Compatibilizer | 3% Compatibilizer |
| Additive 3 | — | — | — | — | 1.2% Hydrolysis |
| | | | | | stabilizer |
| Melting temp. phase 1 [° C.] | 253 | 253 | 253 | 253 | 253 |
| Melting temp. phase 2 [° C.] | — | 120 | 120 | 120 | 120 |
| Tenacity [gpd] | 2.9 | 3.1 | 2.9 | 2.8 | 3.1 |
| Elongation at break [%] | 45 | 47 | 46 | 54 | 45 |
| Young's Modulus [gpd] | 72 | 71 | 70 | 63 | 60 |
| Shrinkage [%] | 15 | 15.8 | 17 | 12 | 11 |
| Strength retained [%] after | 69 | 63 | 38 | 30 | 85 |
| hydrolysis at 140° C., | | | | | |
| 24 hours | | | | | |
| Strength retained [%] after | 46 | 44 | 51 | 54 | 80 |
| dry heat at 204° C., 24 hours | | | | | |

All the different components are added in % by weight.

Table 1 is showing a comparison between a standard PET monofilament yarn (Reference) and monofilament yarns according to the invention (Sample 1 to Sample 4) having the same yarn diameter (0.7 mm) as the reference yarn.

As can be seen in Table 1, the yarns of samples 1 to 4 have two melting temperatures. A melting temperature of the first phase which is at 253° C. and a melting temperature of 120° C. of the second phase. Therefore the yarn according to the invention has a melting temperature (120° C.) which is in the temperature range of typical heat set treatments (90° C. to 220° C.) and a melting temperature which is higher than the heat set temperature.

Sample 1 to 4 are made from a polymer blend including the polymer components PET and PE, wherein the first phase is formed by the PET polymer component and the second phase is formed by the PE polymer component. PET and PE are immiscible polymers and therefore generate a blend with two phases.

As cain be seen especially sample 1, 2 and 4 have approximately the same mechanical properties as the reference sample. Sample 1 has the same degradation resistance as the reference sample.

To improve processability samples 3 and 4 include 3% of a compatibilizer.

To improve the resistance to dry heat treatment, sample 3 further includes 1% of an anti-oxidant stabilizer. As can be seen the strength retained after dry heat treatment is increased to 54%.

To improve hydrolysis resistance sample 4 further includes a hydrolysis stabilizer in an amount of 1.2%. As can be seen from Table 1 sample 4 has the best dry heat and wet heat resistance behaviour.

### BRIEF DESCRIPTION OF THE DRAWINGS

The invention shall be further illustrated with the following figures, wherein

FIGS. 1(a) and 1(b) show a comparison between the paper contacting surface of a dryer fabric made from standard yarn material and a dryer fabric made from yarn material according to the invention,

FIGS. 2(a) and 2(b) show the difference in contact area between the dryer fabric according to the invention and a standard dryer fabric,

FIGS. 3(a) and 3(b) show the difference in crimp level between the dryer fabric according to the invention and an standard dryer fabric, and

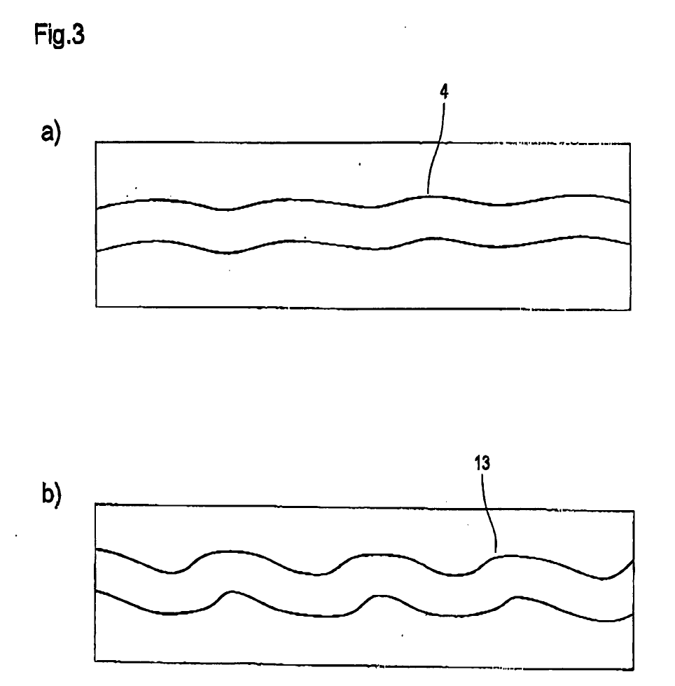

FIG. 4 shows the weave design of fabrics 1 and 10 in warp yarn direction.

### DETAILED DESCRIPTION OF THE INVENTION

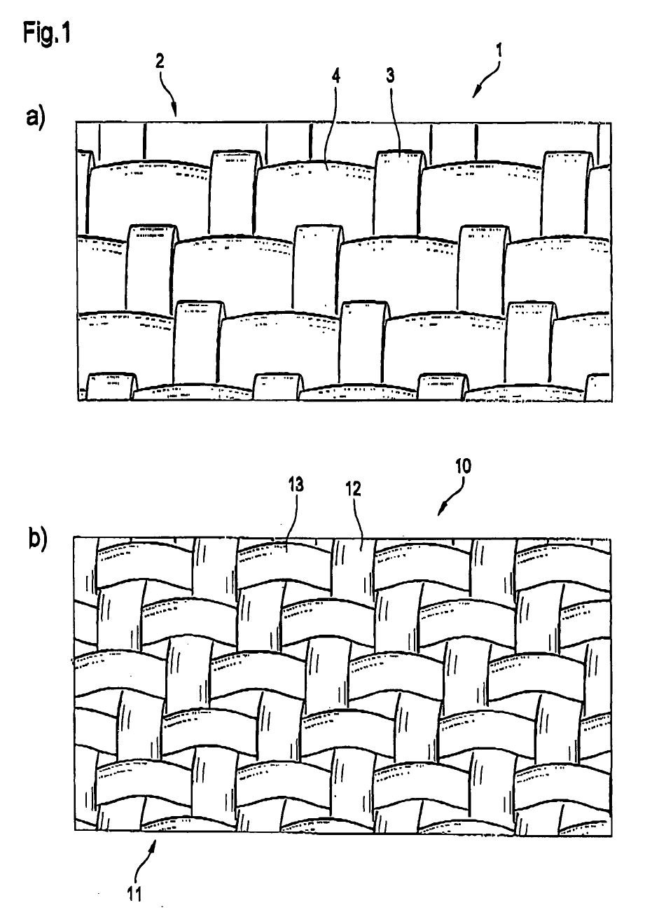

FIGS. 1(a) and 1(b) show photographs of the paper contacting surface of a dryer fabric 1 made from standard yarn material and a photograph of the paper contacting surface of a dryer fabric 10 made from yarn material according to the invention.

It has to be noted that both fabrics 1, 10 have the same weave design and that the weft and the warp yarns of both fabrics have the same diameter. Further both fabrics are manufactured identically at least in terms of the heat set treatment which had been performed applying a tension in the range of 1.5 kN/m to 5 kN/m to the warp yarns with a temperature in the range of 170° C. to 220° C.

FIG. 1(a) shows the paper contacting surface 2 of the fabric 1 having warp 3 and weft 4 yarns made from 100% PET.

FIG. 1(b) shows the paper contacting surface 11 of the fabric 10 having warp yarns 12 made from 100% PET and having weft yarns 13 made from a PET-PE polymer blend according to the invention.

As can be seen in FIG. 1(a), the weft yarns 4 of the fabric 1 substantially extend in a straight line having a low crimp level. Measurements have shown a crimp level in the 4% range. In contrast thereto the warp yarns 3 have a high crimp level which is approximately 19%. Therefore the paper contacting surface of the dryer fabric 1 only has a contact area 5 of the dryer fabric 10 of 22% (grey coloured) as shown in FIG. further 2(a). Further, the crimp level ratio of warp yarn to weft yarn is 4.75.

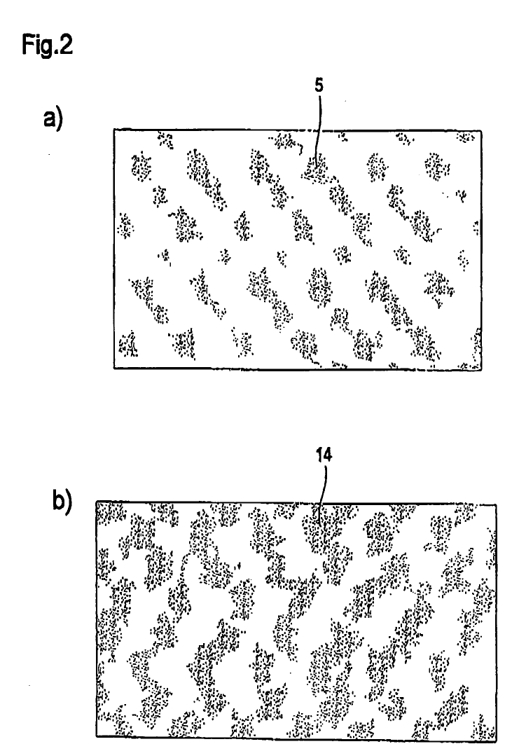

As can be seen in FIG. 1(b), the weft yarns 13 of the fabric 10 extend in a crimped line having a high crimp level compared with the crimp level of the weft yarns 4 according to FIG. 1a. Measurement have shown a crimp level of the wefts 13 is in the 5.5% range. Further, the warp yarns 12 have a lower crimp level than the warp yarns 3 of the dryer fabric 1. The crimp level of the warp yarns 12 is approximately 10%. Therefore, the paper contacting surface of the dryer fabric 10 has an enhanced contact area 14 of 30% (grey coloured) as shown in FIG. 2(b) compared to the contact area 5 of the dryer fabric 1 which is 22% (grey coloured) as shown in FIG. 2(a). According to the invention, the crimp level ratio of warp yarn to weft yarn is 1.8.

Figures (a) and (b) show the difference in crimp level between a weft yarn 13 of the dryer fabric 10 according to the invention and a weft yarn 4 of the standard dryer fabric 1.

A weft yarn of a fabric according to the invention can have a crimp level in the range of 5.0% to 7.0%, typically in the range of 5.5% to 6.5%, depending on the specific weave design, the yarn diameter and the heat set conditions.

The weft yarns 13 of the fabric 10 has a crimp level of 6.0%.

A weft yarn of a fabric known in the art can have a crimp level in the range of 3.5% to 5.5%, typically in the range of 4.0% to 5.0%, depending on the specific weave design, the yarn diameter and the heat set conditions.

The weft yarns 4 of the fabric 1 has a crimp level of 4.0%.

For the same weave design and the same manufacturing conditions the weft yarns of a fabric according to the invention has an enhanced crimp level of at least 0.5%, preferably at least 1.0%, most preferably at least 1.5% and preferred in the range of 1.5% to 2.5%.

In the concrete embodiment of FIGS. 1(a) and 1(b), the difference in crimp level between fabric 10 and 1 is 2%.

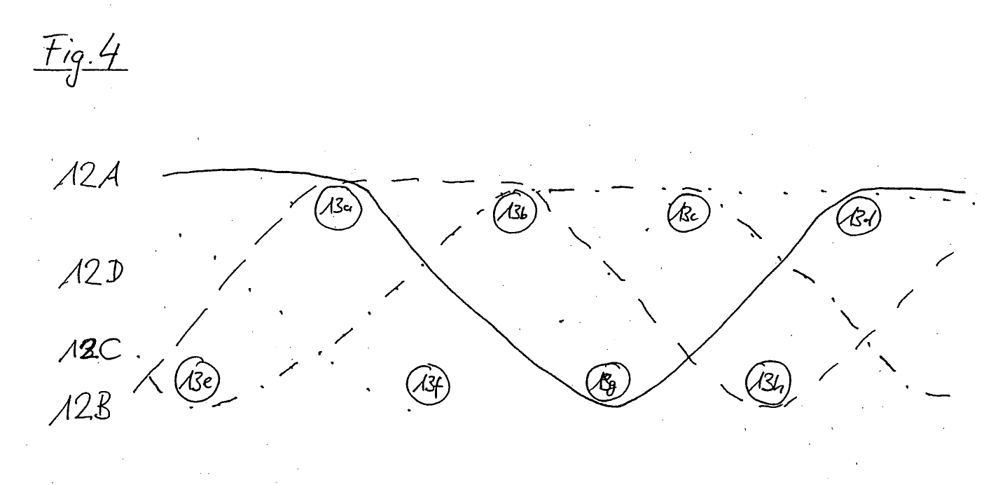

FIG. 4 shows the weave design of fabrics 1 and 10 in warp yarn direction. For further discussions the weave design will be discussed by reference numbers of fabric 10.

Fabric 10 comprises first weft yarns 13a, 13b, 13c, 13d and second weft yarns 13e, 13f, 13g and 13h. The first weft yarns 13a, 13b, 13c, 13d are disposed over the second weft yarns 13e, 13f, 13g and 13h. Further first weft yarns 13a, 13b, 13c, 13d are in offset position relative to second weft yarns 13e, 13f, 13g and 13h.

As can be seen warp yarns 12A, 12B, 12C and 12D weave over two consecutive first weft yarns before weaving under one second weft yarn.

By way of example warp yarn 12B (dashed line) weaves over consecutive first weft yarns 13a and 13b before weaving under second weft yarn 13h.

In addition, adjacent warp yarns weave in offset position relative to each other over the two consecutive first weft yarns, wherein the offset position is defined by one first weft yarn.

By way of example warp yarn 12B weaves over first weft yarns 13a and 13b, wherein adjacent warp yarn 12C (dash dotted line) weaves over first weft yarns 13b and 13c. Therefore the offset between warp yarn 12B and warp yarn 12C is defined by one first weft yarn.

As can be seen the weave repeat comprises four warp yarns 12A to 12D and four first weft yarns 13a, 13b, 13c, 13d and four second weft yarns 13e, 13f, 13g 13h.

1-49. (canceled)

50. Yarn for an industrial fabric, which fabric will be subjected to heat set treatment during manufacture, said yarn being composed of polymeric material, said polymeric material including a first phase having a melting temperature and a second phase having a melting temperature, the melting temperature of the second phase is equal to or less than a maximum heat set temperature and the melting temperature of the first phase is higher than the maximum heat set temperature.

51. Yarn according to claim 50, wherein the maximum heat set temperature is in a range of 90° C. and 260° C.

52. Yarn according to claim 51, wherein the melting temperature of the second phase is higher than a maximum operation temperature at which the industrial fabric will be operated.

53. Yarn according to claim 51, wherein the second phase is an amorphous phase and the melting temperature of the amorphous second phase is a softening temperature.

54. Yarn according to claim 51, wherein the polymeric material is a polymer blend, the first phase including a first polymer component and the second phase including a second polymer component, and the first polymer component and the second polymer component are substantially immiscible.

55. Yarn according to claim 54, wherein the melting temperature of the second phase is in a range of 120° C. to 220° C.

56. Yarn according to claim 55, wherein the melting temperature of the second phase is in a range of 160° C. to 220° C.

57. Yarn according to claim 51, wherein the melting temperature of the second phase is in a range of 120° C. to 220° C.

58. Yarn according to claim 57, wherein the melting temperature of the second phase in a range of 160° C. to 220° C.

59. Yarn according to claim 51, wherein the melting temperature of the second phase is at least 30° C. lower than the melting temperature of the first phase.

60. Yarn according to claim 59, wherein the melting temperature of the second phase is at least 80° C. lower than the melting temperature of the first phase.

61. Yarn according to claim 51, wherein the melting temperature of the second phase is between 100° C. and 110° C. lower than the melting temperature of the first phase.

62. Yarn according to claim 51, wherein the first phase comprises at least one of homopolymers and copolymers of polyesters, homopolymers and copolymers of polyamides, polyphenylene sulphide, either alone or blended.

63. Yarn according to claim 62, wherein the first phase includes polyethylene terephthalate.

64. Yarn according to claim 51, wherein the second phase comprises at least one of polyolefins, polyamides, fluoropolymers, either alone or blended.

65. Yarn according to claim 54, wherein the blend includes between 51% and 99% by weight of the first polymer component and between 49% and 1% by weight of the second component.

66. Yarn according to claim 65, wherein the blend includes between 60% and 95% by weight of the first polymer component and between 40% and 5% by weight of the second component.

67. Yarn according to claim 54, wherein the polymer blend comprises at least one compatibilizer.

68. Yarn according to claim 67, wherein the at least one compatibilizer is included in an amount of 0.01% to 10% by weight.

69. Yarn according to claim 68, wherein the at least one compatibilizer is included in an amount of 0.1% to 5% by weight.

70. Yarn according to claim 67, wherein the at least one compatibilizer is a physical compatibilizer.

71. Yarn according to claim 70, wherein the physical compatibilizer comprises ethylene methyl acrylate copolymer or ethylene butyl acrylate copolymer.

72. Yarn according to claim 67, wherein the at least one compatibilizer is a reactive compatibilizer.

73. Yarn according to claim 72, wherein the reactive compatibilizer comprises ethylene-g- maleic anhydride copolymers or ethylene-g- glycidal methacrylate.

74. Yarn according to claim 54, wherein the polymer blend comprises at least one stabilizer.

75. Yarn according to claim 74, wherein the at least one stabilizer is included in an amount of 0.1% to 10% by weight.

76. Yarn according to claim 75, wherein the at least one stabilizer is included in an amount of 0.5% to 5% by weight.

77. Yarn according to claim 74, wherein the at least one stabilizer is a hydrolysis stabilizer.

78. Yarn according claim 77, wherein the hydrolysis stabilizer is a carbodiimide compound.

79. Yarn according to claim 74, wherein the at least one stabilizer is an anti-oxidation stabilizer.

80. Yarn according to claim 51, wherein said yarn has a tensile elongation of at least 10% at 1.75 grams per denier.

81. Yarn according to claim 51, wherein the yarn has at least one of an elongation at yield point 1 which is greater than 5% and an elongation at yield point 2 which is greater than 20%.

82. Yarn according to claim 51, wherein the yarn is a monofilament yarn.

83. Yarn according to claim 51, wherein the yarn is a multifilament yarn.

84. Yarn according to claim 51, wherein the yarn has a diameter in the range of 0.20 mm to 2.0 mm.

85. Yarn according to claim 84, wherein the yarn has a diameter in the range of 0.4 mm to 1.0 mm.

86. Yarn according to claim 51, wherein the yarn has a shape which is round.

87. Yarn according to claim 51, wherein the yarn has a shape which is profiled with chamfered edges.

88. Industrial fabric comprising:
a set of weft yarns and a set of warp yarns, said set of warp yarns and said set of weft yarns are interwoven to form a fabric comprising a specific weave design; and
at least one of said weft yarns and one of said warp yarns of said fabric has an enhanced level of crimp of at least 0.5% compared to a corresponding weft yarn or warp yarn of a reference fabric, said reference fabric having the same weave design as said fabric, all weft and warp yarns of said reference fabric having the same diameter as the weft and warp yarns of said fabric, said reference fabric having been manufactured under the same conditions as said fabric, and said corresponding weft and/or warp yarns of said reference fabric are made from polyethylene terephthalate based polymeric material.

89. Industrial fabric according to claim 88, wherein the enhanced level of crimp is at least 1.0%.

90. Industrial fabric according to claim 89, wherein the enhanced level of crimp is at least 1.5%.

91. Industrial fabric according to claim 89, wherein the enhanced level of crimp is in a range of 1.5% to 2.5%.

92. Industrial fabric according to claim 88, wherein during production said fabric and said reference fabric have been subjected to heat set treatment, wherein during heat set treatment tension selected from a range of 1 kN/m to 6 kN/m and temperature with a maximum temperature selected from the range of 90° C. to 260° C. has been applied.

93. Industrial fabric comprising a set of weft yarns and a set of warp yarns wherein the warp yarns and the weft yarns are interwoven with each other and having a crimp level after heat set treatment, wherein during heat set treatment a tension of 1 kN/m to 6 kN/m, and a temperature of 90° C. to 260° C. is applied, and at least one warp yarn of the warp yarn set and at least one weft yarn of the weft yarn set has a crimp level ratio which is less than 4, wherein the crimp level for each yarn is the difference of the length along the crimped line of the yarn and the length along the straight line of the yarn divided through the length along the straight line of the yarn.

94. Industrial fabric according to claim 93, wherein a tension of 1.5 kN/m to 5 kN/m and a temperature of 160° C. to 220° C. is applied,

95. Industrial fabric according to claim 93, wherein the ratio of the crimp level of at least one warp yarn to the crimp level of at least one weft yarn is less than 3.5.

96. Industrial fabric according to claim 95, wherein the ratio of the crimp level of at least one warp yarn to the crimp level of at least one weft yarn is less than 3.0.

97. Industrial fabric according to claim 96, wherein the ratio of the crimp level of at least one warp yarn to the crimp level of at least one weft yarn is less than 2.

98. Industrial fabric according to claim 93, wherein at least one of said weft and warp yarns is made from a polymer blend, wherein said polymer blend includes a first polymer component and a second polymer component, the first polymer component and the second polymer component are immiscible, and the second polymer component has a melting temperature being equal to or less than the maximum heat set temperature and the first polymer component has a melting temperature higher than the maximum heat set temperature.

99. Industrial fabric according to claim 98, wherein the maximum heat set temperature is in a range of 90° C. and 260° C.

100. Industrial fabric according to claim 98, wherein the polymer blend yarns are at least one of weft and warp yarns.

101. Industrial fabric according to claim 98, wherein the polymer blend yarns have been subjected to tension during heat set treatment resulting in a crimp level in the range of 4.0% to 6.5%.

102. Industrial fabric according to claim 101, wherein the polymer blend yarns have been subjected to tension during heat set treatment resulting in a crimp level in the range of 4.5% to 6.0%.

103. Industrial fabric according to claim 98, wherein the industrial fabric is a papermaking fabric.

104. Industrial fabric according to claim 103, wherein the papermaking fabric comprises a forming or a dryer fabric or a base of a press fabric.

105. Industrial fabric according to claim 103, wherein the papermaking fabric comprises a dryer fabric, and the dryer fabric has an air permeability in a range from 50 to 200 cfm.

106. Industrial fabric according to claim 103, wherein the papermaking fabric comprises a dryer fabric, and the dryer fabric has an air permeability in a range from 75 to 150 cfm.

107. Industrial fabric according to claim 98, wherein said set of weft yarns comprises first and second weft yarns, said first weft yarns being disposed over said second weft yarns and wherein said warp yarns weave over two consecutive first weft yarns before weaving under one second weft yarn.

108. Industrial fabric according to claim 107, wherein said first weft yarns are in offset position relative to said second weft yarns.

109. Industrial fabric according to claim 108, wherein adjacent warp yarns weave in offset position relative to each other over said two consecutive first weft yarns.

110. Industrial fabric according to claim 109, wherein said offset position of said adjacent warp yarns is at least one first weft yarn.

111. Industrial fabric according claim 110, wherein a weave repeat comprises four warp yarns and four first and four second weft yarns.

112. Industrial fabric according to claim 111, wherein the weft yarns have the enhanced level of crimp.

113. Yarn for an industrial fabric, said yarn having a tensile elongation of at least 10% at 1.75 grams per denier.

114. A process of making an industrial yarn according to claim 50, which fabric will be subjected to heat set treatment during manufacture, comprising forming a yarn composed of polymeric material, the polymeric material including a first phase having a melting temperature and a second phase having a melting temperature, the melting temperature of the second phase is equal to or less than a maximum heat set temperature and the melting temperature of the first phase is higher than the maximum heat set temperature.

115. The process according to claim 114, wherein the maximum heat set temperature is in a range of 90° C. and 260° C., the melting temperature of the second phase in a range of 120° C. to 220° C., and the melting temperature of the second phase is at least 30° C. lower than the melting temperature of the first phase.

116. A process of manufacturing an industrial fabric according to claim 88, comprising:
interweaving a set of warp yarns and a set of weft yarns to form a fabric comprising a specific weave design; and
subjecting the fabric to heat set treatment so that at least one of the weft yarns and one of the warp yarns of the fabric has an enhanced level of crimp of at least 0.5% compared to a corresponding weft yarn or warp yarn of a reference fabric, the reference fabric having the same weave design as the fabric, all weft and warp yarns of the reference fabric having the same diameter as the weft and warp yarns of the fabric, the reference fabric having been manufactured under the same conditions as the fabric, and the corresponding weft and/or warp yarns of the reference fabric are made from polyethylene terephthalate based polymeric material.

117. The process according to claim 116, wherein the subjecting the fabric to heat set treatment comprises not tensioning at least one of the yarns that has an enhanced level of crimp.

118. The process according to claim 117, wherein the at least one yarn that is not tensioned is a weft yarn.

119. The process according to claim 116, wherein the subjecting the fabric to heat set treatment comprises not tensioning all of the yarns that have an enhanced level of crimp.

120. A process of manufacturing an industrial fabric according to claim 93, comprising:
interweaving an Industrial fabric comprising a set of weft yarns and a set of warp yarns wherein the warp yarns and the weft yarns are interwoven with each other and have a crimp level after heat set treatment;
applying during heat set treatment a tension of 1 kN/m to 6 kN/m, and a temperature of 90° C. to 260° C., and at least one warp yarn of the warp yarn set and at least one weft yarn of the weft yarn set has a crimp level ratio which is less than 4, wherein the crimp level for each yarn is the difference of the length along the crimped line of the yarn and the length along the straight line of the yarn divided through the length along the straight line of the yarn.

121. The process according to claim 120, comprising applying a tension of 1.5 kN/m to 5 kN/m and a temperature of 160° C. to 220° C.

122. The process according to claim 120, wherein the ratio of the crimp level of at least one warp yarn to the crimp level of at least one weft yarn is less than 3.5.

123. The process according to claim 122, wherein the ratio of the crimp level of at least one warp yarn to the crimp level of at least one weft yarn is less than 3.0.

124. The process according to claim 123, wherein the ratio of the crimp level of at least one warp yarn to the crimp level of at least one weft yarn is less than 2.
